(19) United States
(12) Patent Application Publication
(10) Pub. No.: US 2013/0248015 A1
(43) Pub. Date: Sep. 26, 2013

(54) Shut-Off Valve For Cisterns, Tanks and Similar

(71) Applicant: RIV RUBINETTERIE ITALIENE VELATTA SPA, Grignasco (IT)

(72) Inventors: Artemio Velatta, Grignasco (IT); Ruben Velatta, Grignasco (IT)

(73) Assignee: RIV Rubinetterie Italiene Velatta SpA, Grignasco (IT)

(21) Appl. No.: 13/624,123

(22) Filed: Sep. 21, 2012

(30) Foreign Application Priority Data
Mar. 23, 2012 (IT) MI2012U000120

(51) Int. Cl. F16K 49/00

(52) U.S. Cl. CPC F16K 49/005
USPC 137/340

(57) ABSTRACT

A shut-off valve (10) for cisterns, tanks and similar, in particular for cisterns and tanks transported or driven by articulated road vehicles and agricultural vehicles, includes a metallic body (12) with an upper opening (28) as well as inlet and outlet mouths of a fluid; the valve integrates two paired gates (22), connected between them and operable to be lifted and lowered with a lever and constituting the shut-off means of this fluid. A duct (30) is formed at least partly around the body (12) from which it is hydraulically independent, with opposed inlet and outlet openings (34,36) formed on respective and integral extensions (32) of the duct itself; the duct is formed integrally with the said valve body (12) upon its forming, and shares a common wall (12′) with the valve body for conduction of heat from fluid in the duct to the interior of the valve body.

### RELATED APPLICATIONS/PRIORITY BENEFIT CLAIM

This application claims the benefit of Italy Utility Model Application No. MI2012U000120, filed Mar. 23, 2012 by the same inventors (Artemio Velatta and Ruben Velatta), the entirety of which utility model application is hereby incorporated by reference.

### FIELD

This invention refers generally to a shut-off valve for cisterns, tanks and similar. Specifically, this invention refers to shut-off valves, or gates, with heating elements, adapted for installation on cisterns or tanks transported or driven by articulated road vehicles and agricultural vehicles transporting liquid products, or used on cisterns or fixed tanks positioned outdoors.

### BACKGROUND

Shut-off valves used on outdoor cisterns or tanks are typically hand-operated with a lever. On cisterns driven by articulated road vehicles and agricultural vehicles a valve, or gate valve, is installed, through which the product in the tanks is unloaded, generally in the liquid state, such as water and other substances. The valve includes one or more mobile gates that when necessary are lifted through the manual operation of a lever applied on the valve itself to open the valve and empty the product from the cistern or tank.

In farming, the valve is present on the so-called vacuum tankers that carry water or sewage-like fertilizers.

The use of such valves or gates on cisterns or tanks transported by vehicles feature a significant disadvantage related to the climate/environmental conditions in which these means operate. Specifically, ice forms inside these valves in case of very cold temperatures and due to liquid residues in contact with the seats of movable gates. Typically, these valves are exposed since they are fastened to a wall of the cisterns or tanks and are directly affected by atmospheric temperatures. The formation of ice easily blocks the gates and prevents the valve from opening when needed to unload the product. Action exerted with force on the lever of the valve to try to release the gates sometimes is not sufficient, and ice that forms inside the valve can cause breakages that can require the replacement of the valve itself.

To solve this problem, many devices have been conceived for application to the mentioned valves to heat their surface, with the result that heat is transmitted gradually inside the body by conduction to thaw the ice. One of these prior devices is formed of a rigid pipe, shaped to surround part of the valve. This pipe is fastened with screws or similar to the valve body and is fitted with opposed inlet and outlet orifices for liquid circulation, typically that of the cooling radiator of the vehicle's motor. This solution however has a few disadvantages, since this heat pipe element is applied to the outside of the valve. The application of the pipe to the valve body sometimes in fact requires quite complex interventions, which entail partial disassembly of the valve body itself to fasten the pipe with the previously removed screws or similar fasteners. Instead of the fastening with screws a connection can be made with welding, but this is a structural modification that requires time and entails additional costs.

Another disadvantage with the application of a heating pipe consists in that the pipe remains outside the valve body, so it is exposed to the risk of accidental shocks that could harm its integrity. To avoid this, the pipe should be particularly solid as a structure and this requirement brings about high costs. In addition, being outside the valve body, the pipe is directly affected by atmospheric temperature and the heat of the fluid circulating inside the pipe is wasted to a large extent without radiating inside the valve body itself, also because this pipe is not in direct contact with the valve body. This means that removing the ice that blocks the gate of the valve can require a long time, most of all if the vehicle remains for many hours outdoors in very cold temperatures.

### BRIEF SUMMARY

The aim of this invention is to solve the above-mentioned disadvantages. Specifically, the aim of this invention is to provide a shut-off valve that, to remove the ice that forms inside it, does not require having an additional component fastened to its exterior.

Another aim of the invention is to provide a valve as defined above in which ice removal inside is fast and efficient and without a noteworthy heat loss from the heating fluid. Another aim of the invention is to provide the users with a shut-off valve for cisterns, tanks and similar, apt to guarantee a high level of long-lasting resistance and reliability, such as to be easily and cost-effectively made.

These aims and others are reached with a shut-off valve for cisterns, tanks and similar of this invention, specifically for cisterns and tanks transported or driven by articulated road vehicles and agricultural vehicles, comprising a metallic body with an upper mouth as well as opposed inlet and outlet fluid spouts, with two paired gates connected between them and operated by lifting and lowering and comprising the shut off means for the fluid, and characterized mainly in that the shut off valve includes a duct formed at least partially around the body from which it is hydraulically independent and that exits or terminates in opposed holes or openings formed on respective and integral extensions of the duct, the duct being made jointly with the said valve body upon its forming.

### BRIEF DESCRIPTION OF THE DRAWINGS

Manufacturing and functional characteristics of the shut-off valve for cisterns, tanks and similar of this invention can be further understood in the following detailed description, that refers to the attached drawings that represent a preferred form embodiment and in which:

FIG. 1 represents schematically, in a perspective view, the shut-off valve of this invention;

FIG. 2 is an additional schematic perspective, according to a different angle, of the same valve;

FIG. 3 represents schematically a view from the lower or bottom end of the valve itself;

FIG. 4 is a longitudinal section, along line A-A of FIG. 3, of the same valve;

FIG. 5 represents schematically a longitudinal section of the same valve, highlighting one part of the lever that handles fluid shut-off means;

FIG. 6 is a longitudinal section along line B-B of FIG. 5 of the same valve.

### DETAILED DESCRIPTION

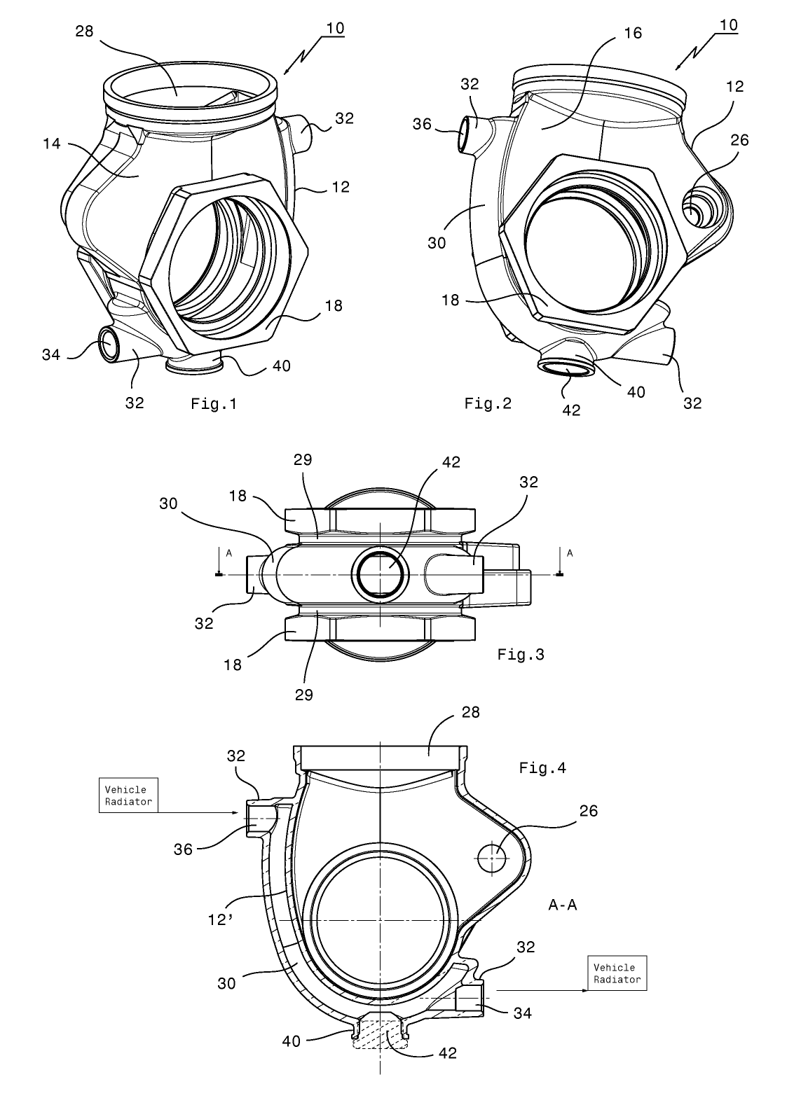

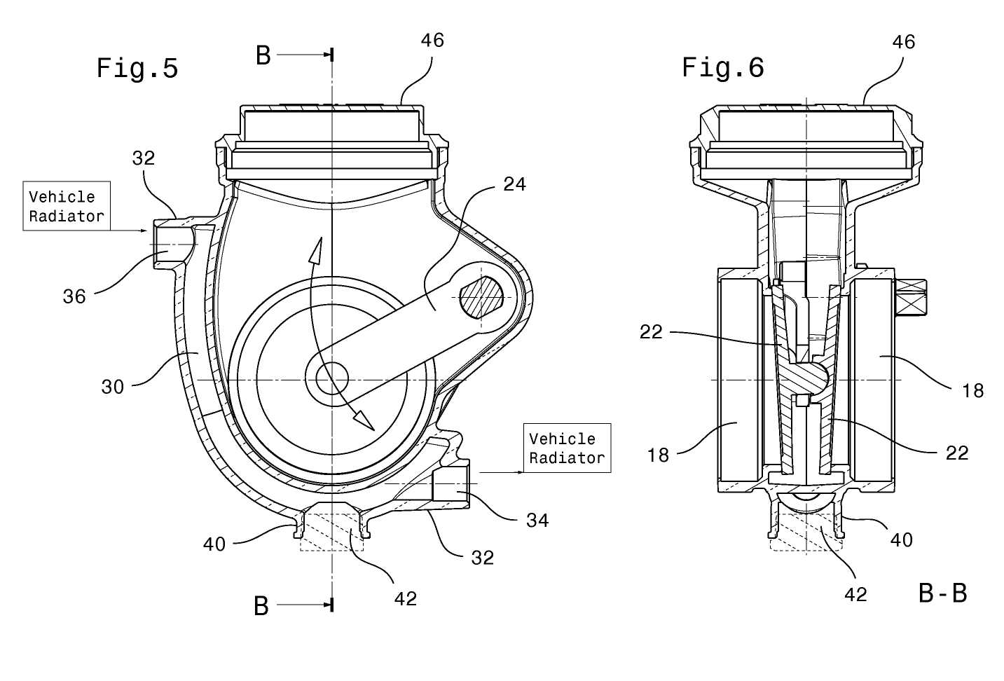

With initial reference to FIGS. 1 and 2, the shut-off valve of this invention, indicated generally with 10, includes a metallic body 12 with a substantially ovoid profile, whose opposed front and back faces define respective flattened surfaces 14, 16 on each of which a cantilevered circular opening 29 is formed delimited by a ring nut or hexagonal nut 18. The openings 29 delimited by nuts 18 form respective inlet and outlet mouths for the fluid contained in the cistern, tank or similar. In body 12 of valve 10 are located the shut off means for this fluid, outlined in FIG. 6 and composed of two paired gates 22 connected between the openings 29 and lifted and lowered through a lever in conventional fashion. This lever is outlined partially with 24 in FIG. 5 and includes a hinged arm on one end at the centre of the gates 22 and, on the other end, connected to an external operating lever (not illustrated). The through hole indicated with 26 in FIG. 2, made on either the front or back face 14 or 16 of body 12, forms the pull-in seat for this operating lever. The upper part of valve 10 defines a mouth 28 closed after by a plug 46.

According to the invention, in body 12 of valve 10 an integral duct 30 is made that wraps at least partially the valve body 12 itself as best shown in FIG. 4, following the ovoid valve body profile along the side wall of the valve body from bottom to top, beginning with its lower arched-convex portion corresponding to the lower half of the circular fluid inlet and outlet openings 29. As shown in FIG. 3, the duct 30 also extends from front to back across the valve body side wall between opposite circular openings 29 delimited by ring nuts or nuts 18. The duct 30, outlined specifically in FIGS. 4 and 5, is formed by casting during the forming of valve 10 and develops peripherally to the valve body itself without fluid communication with the valve interior; i.e., the duct 30 is hydraulically independent or sealed relative to the valve body interior. As best shown in FIG. 4, the side wall 12′ of the valve body forms the inner wall or surface of duct 30. Specifically, according to a preferred form of embodiment, duct 30 embraces almost the entire lower half part of body 12 corresponding to the lower half of the fluid inlet and outlet openings 29 (FIG. 4), and extends upwardly on at least one of its flanks or sides along side wall 12′ until reaching a point proximate the edge of upper mouth 28.

The opposed ends of duct 30, which follows at least in part the perimeter of body 12 of valve 10, exit in respective integral extensions 32, typically with circular section, which form, with respective openings 34 and 36, the inlet and outlet points for the heated fluid circulating through the duct itself. This fluid can come from the cooling radiator of the vehicle, shown schematically in FIG. 4, on which a cistern or a tank is placed with a shut-off valve 10 of this invention.

Along duct 30, which encloses at least part of the perimeter of body 12, another integral threaded extension is made, indicated with 40, which encloses an opening 42 located in the lower part of the valve body. The opening 42, which is closed by a conventional removable threaded plug (shown schematically in phantom), constitutes a point of entrance and of periodic inspection of duct 30, for any removal from the duct itself of solid residues that could progressively reduce its cross-section, thus reducing the efficiency of the heating flow supplied therein.

The duct 30 directly overlies wall 12′ of body 12, providing a direct radiating effect from the hot fluid in the duct to the interior of the valve body itself through the common wall 12′. Consequently the ice formed inside body 12 thaws faster, with a consequent fast restoration of mobility of gates 22 whose lifting allows the outflow of liquids or sewage contained in the cistern or tank. The outlet of these liquids is made, as acknowledged, by connecting a hose to the mouth delimited by one of the flanges or nuts 18. The fluid circulating in the duct 30 can come from the cooling circuit of the motor of the vehicle, as specified above, or alternately from other on-vehicle or off-vehicle circuits in which there is a cooling liquid, or a liquid specifically heated.

As can be understood from the above, the advantages of the invention are clear. The shut-off valve of this invention allows fast thawing of the ice, if any, formed inside the valve, thanks to duct 30 formed integrally with body 12 and directly in touch with the valve body along the full length of the side wall 12′ common to both the valve body and the duct. This duct, being integral to body 12, is adequately protected against shocks, and, furthermore, it is perfectly harmonized with the configuration of the body itself, without highlighting the presence of foreign elements. In addition, with the valve of this invention, traditional disadvantages due to the need to install a specifically fitted pipe on the body of the valve are avoided.

An additional advantage is the ability to easily inspect the duct 30, cleaning the duct if necessary through hole 42 created in the lower part of body 12. Though the invention was described above with special focus on one of its forms of embodiment, by way of example but not restrictive, many modifications and variations will be evident to a technician skilled in the art thanks to the above description. This invention, therefore, aims at embracing all modifications and variations that are within the spirit and the protective framework of the following claims.

It should further be understood that to the extent the term “invention” is used in the written specification, it is not to be construed as a limiting term as to number of claimed or disclosed inventions or discoveries or the scope of any such invention or discovery, but as a term which has long been conveniently and widely used to describe new and useful improvements in science and the useful arts. The scope of the invention should accordingly be construed by what the above disclosure teaches and suggests to those skilled in the art, and by any claims that the above disclosure supports in this application or in any other application claiming priority to this application.

1. A fluid-dispensing shut-off valve for cisterns, tanks and similar, in particular for cisterns and tanks transported or driven by articulated road vehicles and agricultural vehicles or located outdoors, the shut-off valve comprising a metallic heat-conductive body comprising opposed inlet and outlet fluid openings on opposed front and back faces of the valve body, and internal fluid shut-off means located between the inlet and outlet fluid openings and capable of being opened and closed, characterized in that the valve body comprises a duct formed at least partially around a curved sidewall of the valve body between the front and back faces, the duct defining a heating fluid flow path hydraulically independent of the valve body and comprising opposed inlet and outlet holes formed on respective and integral extensions of the duct on opposite sides of the valve body, the duct being integrally formed with the valve body such that an outer surface of the curved side wall of the valve body comprises an inner wall of the duct.

2. A valve according to claim 1, characterized in that the valve body sidewall defines a substantially ovoid profile, the front and back opposed faces comprise respective flattened surfaces, and at least a lower part of the valve body comprising an arched convex contour portion of the sidewall adjacent and corresponding to a lower circumferential portion of the inlet and outlet fluid openings is wrapped by the duct.

3. A valve according to claim 2, characterized in that a portion of the duct corresponding to the lower part of the valve body with the arched convex contour portion of the sidewall includes an integral threaded extension that defines a lower opening comprising an inspection and cleaning access of the duct.

4. A valve according to claim 3, characterized in that the lower opening is closable by a plug screwed on the extension.

5. A valve according to claim 1, characterized in that the valve body comprises, on one of the opposed front and back faces, a through hole where the end of a shutoff handling lever is placed.

6. A valve according to claim 1, characterized in that the extensions of the duct extending from the opposite sides of the valve body are adapted to be connected to a system of a motor vehicle in which a cooling liquid or a heated liquid circulates.

7. A valve according to claim 2, characterized in that the duct extends along the sidewall from a lower part of the valve body along one side of the valve body to an upper part of the valve body along the other side of the valve body.

8. A valve according to claim 7, wherein the valve body comprises an upper opening, and wherein the duct extends along the sidewall from a lower part of the valve body along one side of the valve body to an upper part of the valve body along the other side of the valve body proximate the upper opening.

9. A valve according to claim 8, characterized in that the upper opening is closed.

10. A valve according to claim 8, characterized in that the upper opening is closeable by a plug.

11. A valve according to claim 1, characterized in that the valve body sidewall defines a substantially ovoid profile, the front and back opposed faces comprise respective flattened surfaces, and at least a lower part of the valve body comprising an arched convex contour portion of the sidewall adjacent and corresponding to substantially a lower circumferential half of the inlet and outlet fluid openings is wrapped by the duct.

12. In combination with the valve according to claim 1, a motor vehicle comprising a system in which a cooling liquid or a heated liquid circulate, characterized in that the extensions of the duct extending from the opposite sides of the valve body are connected to the motor vehicle system in which a cooling liquid or a heated liquid circulates.
